(19) United States
(12) Patent Application Publication
(10) Pub. No.: US 2017/0248291 A1
(43) Pub. Date: Aug. 31, 2017

(54) ROTATABLE ILLUMINATOR

(71) Applicant: Ching-Feng Hsu, Taipei (TW)

(72) Inventor: Ching-Feng Hsu, Taipei (TW)

(21) Appl. No.: 15/055,517

(22) Filed: Feb. 26, 2016

(51) Int. Cl. F21V 19/02; F21S 8/06; F21V 3/00; F21V 1/00; F21V 23/04; F21S 9/02

(52) U.S. Cl. CPC F21V 19/02; F21V 23/04; F21S 9/02; F21V 3/00; F21V 1/00; F21S 8/063; F21Y 2115/10

(57) ABSTRACT

A rotatable illuminator has a housing and an illuminating body. The housing has an inner space and an opening. The illuminating body is rotatably mounted in the housing, and has an illuminating element. When the illuminating body is rotated until the illuminating element is toward the opening of the housing, the rotatable illuminator can be hanged to be used as a hanging lantern, or the user can directly hold the housing to use the rotatable illuminator as a flashlight. When the illuminating body is rotated until the illuminating element is toward the inner space of the housing, the rotatable illuminator can be put on a table to be used as a table lamp. As a result, the rotatable illuminator can be used as the hanging lantern, the flashlight, and the table lamp, and thus can reduce the cost and facilitates ease in portability.

### BACKGROUND OF THE INVENTION

1. Field of the Invention

The present invention relates to a rotatable illuminator, especially to a rotatable illuminator that can be used as a hanging lantern, a table lamp, and a flashlight.

2. Description of the Prior Arts

Illuminators are essential devices nowadays. The illuminators are provided in various forms, such as a table lamp put on a table, a hanging lantern hanged in a high place, and a portable flashlight held in hand. However, the three forms of the illuminators all respectively have one single function. For example, the hanging lantern cannot be put on a table for use. Therefore, the user has to buy different forms of the illuminators for different occasions, which cost a lot. In addition, when the user engages in outdoor activities, such as camping, it is inconvenient for the user to bring the three forms of the illuminator, which increase the weight of the baggage.

To overcome the shortcomings, the present invention provides a rotatable illuminator to mitigate or obviate the aforementioned problems.

### SUMMARY OF THE INVENTION

The main objective of the present invention is to provide a rotatable illuminator that can be used as a hanging lantern, a table lamp, and a flashlight.

The rotatable illuminator has a housing, an illuminating body, and a switch. The housing has an inner space and an opening communicating with the inner space. The illuminating body is rotatably mounted in the housing, is disposed adjacent to the opening of the housing, and has at least one illuminating element. The illuminating body is rotatable relative to the housing to make the at least one illuminating element toward the opening of the housing or toward the inner space of the housing. The switch is mounted on the housing, is electrically connected to the illuminating body, and is disposed in an end of a rotating axis between the housing and the illuminating body.

When the illuminating body is rotated until the at least one illuminating element is toward the opening of the housing, the rotatable illuminator can be hanged to be used as a hanging lantern, or the user can directly grab and hold the housing to use the rotatable illuminator as a flashlight. When the illuminating body is rotated until the at least one illuminating element is toward the inner space of the housing, the rotatable illuminator can be put on a table. At this time, light from the illuminating element penetrates through and emits out of the housing, such that the rotatable illuminator can be used as a table lamp. In addition, regardless of the rotation of the illuminating body relative to the housing, the user still can switch on and off the illuminating body because the switch is disposed in an end of a rotating axis between the housing and the illuminating body. As a result, the rotatable illuminator can be used as the hanging lantern, the flashlight, and the table lamp as mentioned above, and thus can reduce the cost and facilitate ease in portability.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a rotatable illuminator in accordance with the present invention, shown used as a hanging lantern;

FIG. 2 is a perspective view of the rotatable illuminator in FIG. 1, showing an illuminating body rotated;

FIG. 3 is an exploded perspective view of the rotatable illuminator in FIG. 1, shown used as a table lamp;

FIG. 4 is an exploded perspective view of a housing of the rotatable illuminator in FIG. 1;

FIG. 5 is an exploded perspective view of the illuminating body of the rotatable illuminator in FIG. 1;

FIG. 6 is a perspective view of two pivot segments, a switch, and a charging dock of the rotatable illuminator in FIG. 1;

FIG. 7 is a front view in partial section of the rotatable illuminator in FIG. 1;

FIG. 8 is a schematic view of the rotatable illuminator in FIG. 1, shown used as the hanging lantern;

FIG. 9 is a schematic view of the rotatable illuminator in FIG. 1, shown used as a flashlight; and

FIG. 10 is a schematic view of the rotatable illuminator in FIG. 1, shown used as the table lamp.

### DETAILED DESCRIPTION OF THE PREFERRED EMBODIMENTS

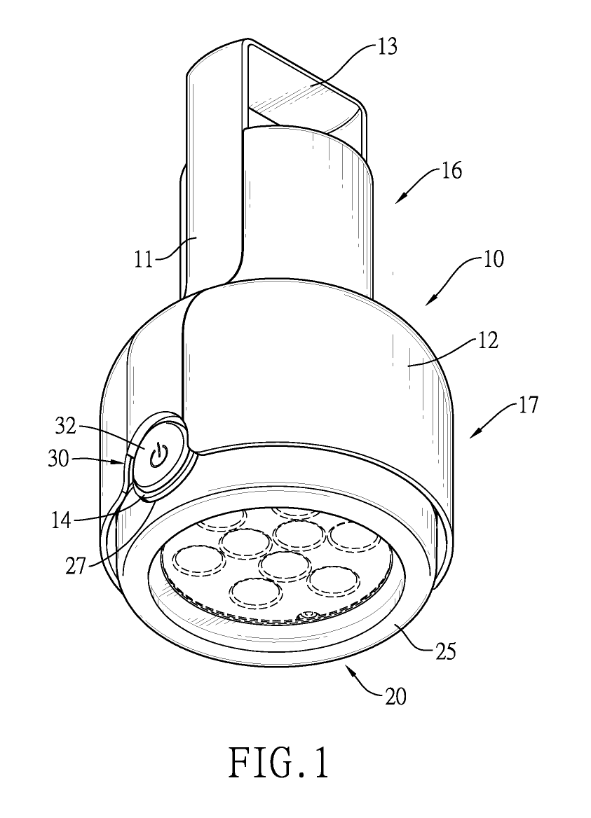

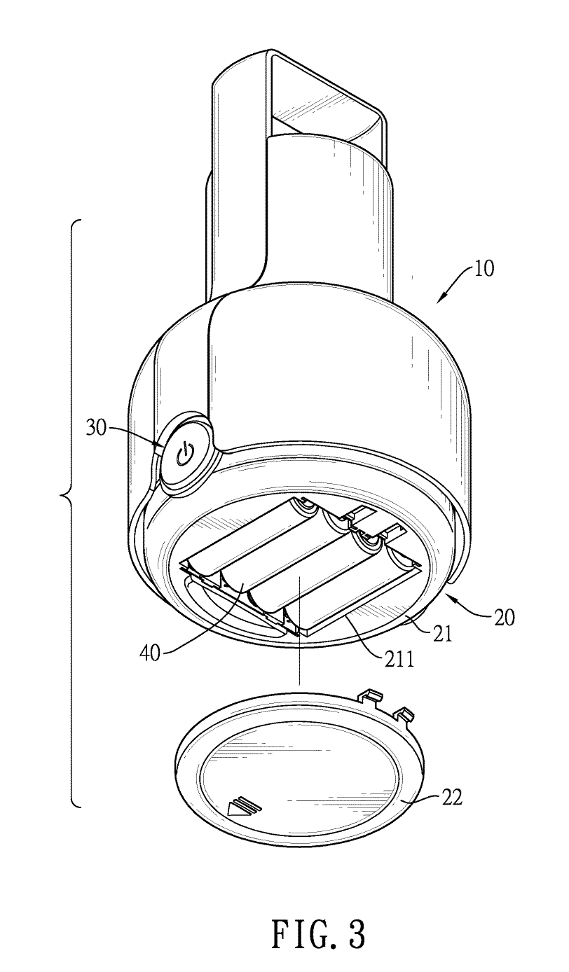

With reference to FIGS. 1 to 4, a rotatable illuminator in accordance with the present invention comprises a housing 10, an illuminating body 20, and a switch 30.

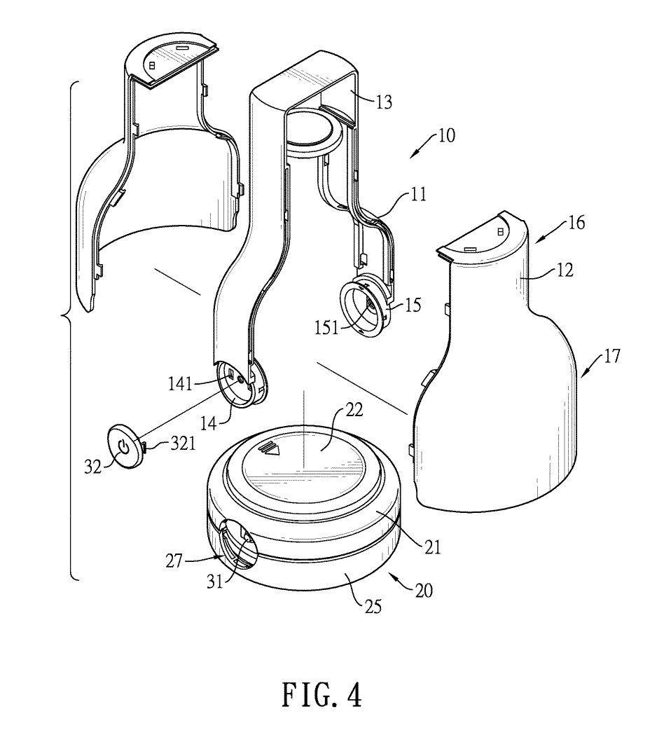

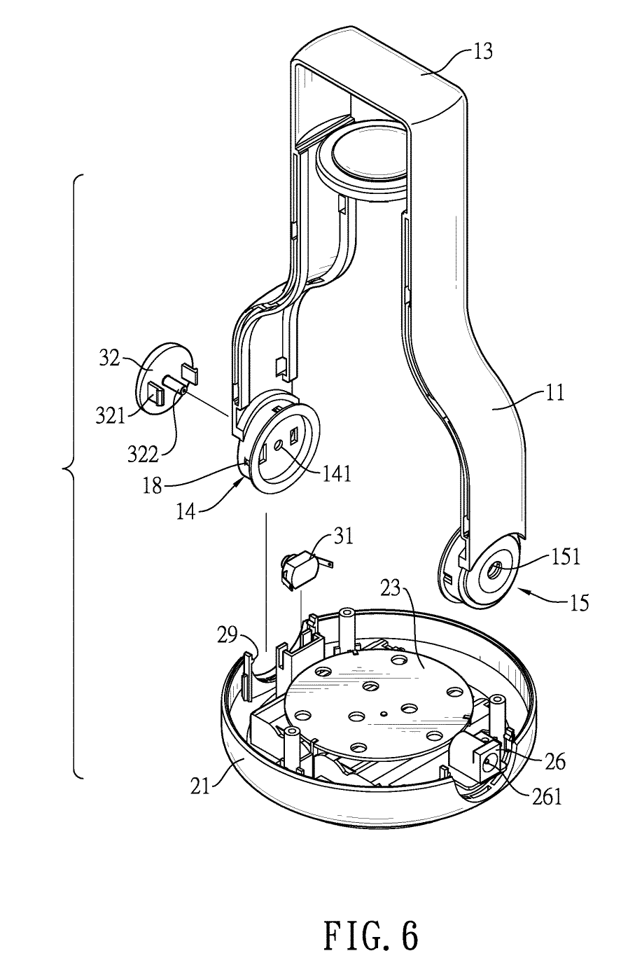

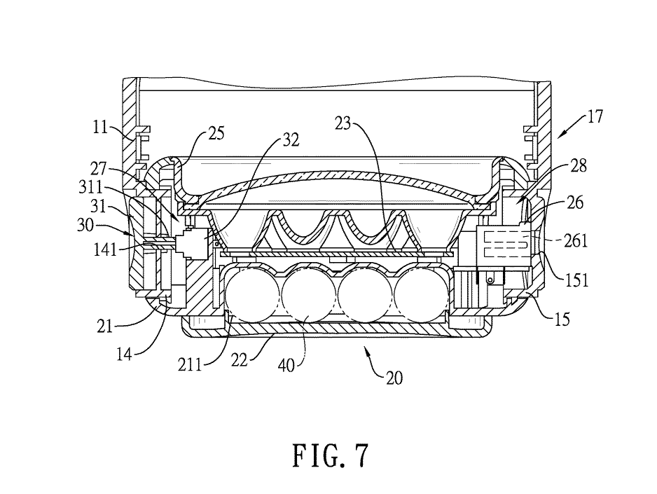

With reference to FIGS. 4, 6, and 7, the housing 10 in the preferred embodiment has a hanging casing 11 and two side casings 12. The hanging casing 11 is elongated and is bent into a U shape. The side casings 12 are respectively mounted on two opposite sides of the hanging casing 11. The side casings 12 and the hanging casing 11 form an inner space and an opening communicating with the inner space. A middle segment of the hanging casing 11 is disposed in an end opposite to the opening and is disposed outside of the side casings 12 to form a hanger 13 for being hanged or grabbed. In a preferred embodiment, the side casings 12 are made of, but not limited to, translucent or transparent material. The hanging casing 11 has a first pivot segment 14 and a second pivot segment 15. The pivot segments 14, 15 are respectively formed on two ends of the hanging casing 11, and face to each other. The first pivot segment 14 has multiple switch holes 141 formed therethrough. The second pivot segment 15 has a charging hole 151 formed therethrough. Each one of the pivot segments 14, 15 has multiple positioning recesses 18 transversely formed in the pivot segment 14, 15 and annularly disposed apart from each other. Outer surfaces of the hanging casing 11 and the side casings 12 together form a holding part 16 and an illuminating part 17. The holding part 16 is smaller than the illuminating part 17 in diameter, and the diameter of the holding part 16 is set at a size suitable for a user to conveniently grab and hold the holding part 16. The hanger 13 is disposed on the holding part 16, and the opening of the housing 10 and the pivot segments 14, 15 are disposed on the illuminating part 17.

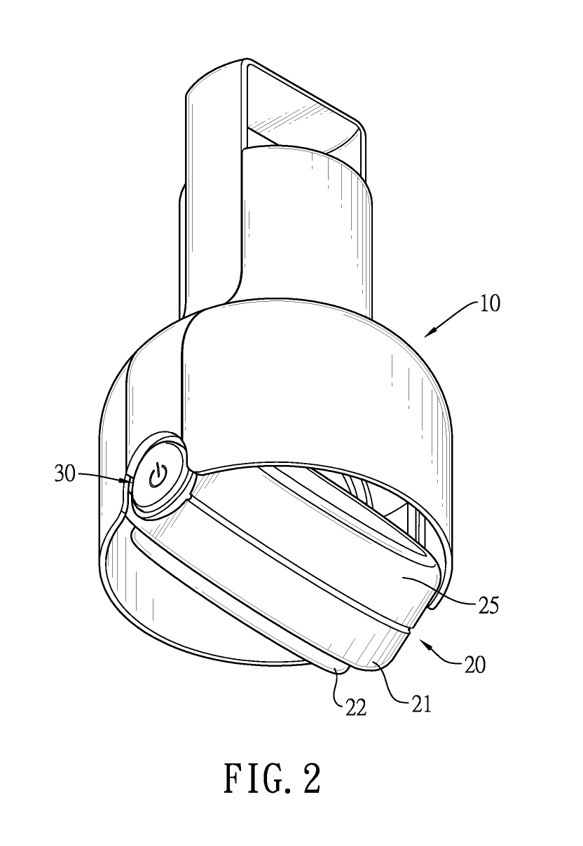

With reference to FIGS. 2, 3, 5, and 7, the illuminating body 20 is rotatably mounted in the illuminating part 17 of the housing 10, is disposed adjacent to the opening of the housing 10, and has an illuminating case 21, a battery cover 22, a circuit board 23, multiple illuminating elements, a lampshade 25, and a charging dock 26. The illuminating case 21 has an inner space and an opening communicating with the inner space of the illuminating case 21. The illuminating case 21 has a battery holder 211 formed in a surface opposite to the opening of the illuminating case 21 for accommodating batteries 40. The battery cover 22 is detachably covered on an opening of the battery holder 211. An outer surface of the battery cover 22 is a plane for abutting the table. The circuit board 23 is mounted in the inner space of the illuminating case 21. The illuminating elements are electrically connected to the circuit board 23. In the preferred embodiment, the illuminating elements are preferably, but not limited to, light-emitting diodes (LEDs). The lampshade 25 is mounted on the opening of the illuminating case 21, and is disposed in an outside of the illuminating elements, such that light from the illuminating elements penetrates through and emits out of the lampshade 25. The lampshade 25 and the illuminating case 21 form a first pivot recess 27 and a second pivot recess 28. The pivot recesses 27, 28 are respectively and rotatably disposed around the pivot segments 14, 15 of the hanging casing 11, such that the whole illuminating body 20 is rotatable relative to the housing 10, and the pivot segments 14, 15 form a rotating axis between the housing 10 and the illuminating body 20. The illuminating body 20 is rotatable relative to the housing 10 to make the illuminating elements toward the opening of the housing 10 or toward the inner space of the housing 10.

Each one of the pivot recesses 27, 28 has two positioning protrusions 29 transversely formed on an inner surface of the pivot recess 27, 28. The two positioning protrusions 29 respectively and selectively engage in two of the positioning recesses 18 of the corresponding pivot segment 14, 15, such that the illuminating body 20 stably remains at the angle at which the illuminating elements are toward the opening of the housing 10 or toward the inner space of the housing 10. The charging dock 26 is electrically connected to the circuit board 23 and is mounted in the second pivot recess 28. The charging dock 26 has a charging hole 261 communicating with the charging hole 151 of the second pivot segment 15, and the charging holes 151, 261 are both circular holes. Therefore, regardless of the relative angle between the illuminating body 20 and the housing 10, the user can insert a connector of the power cord into the charging holes 151, 261 to charge the illuminating body 20.

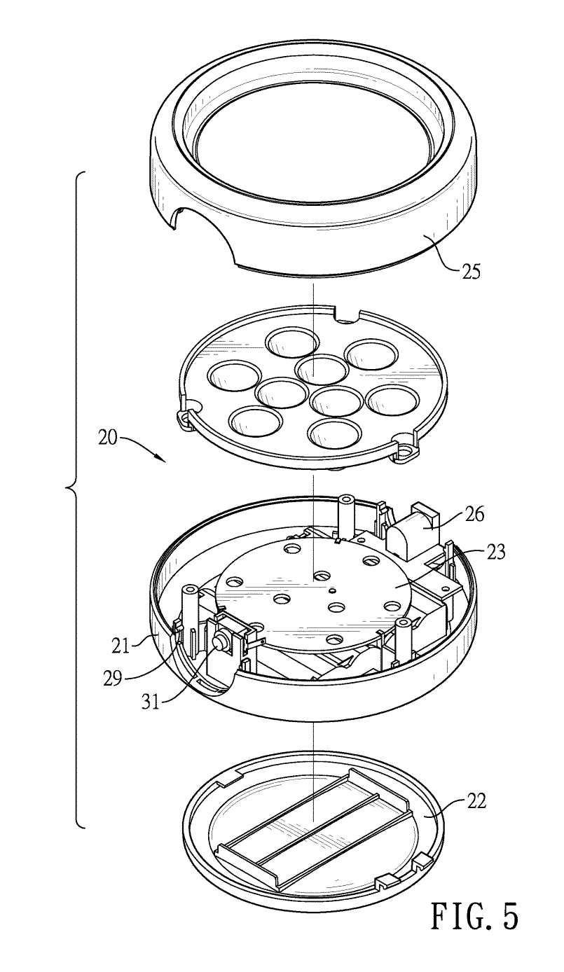

With reference to FIGS. 5 to 7, the switch 30 has a push switch body 31 and a button 32. The push switch body 31 is electrically connected to the circuit board 23 of the illuminating body 20, and is mounted in the first pivot recess 27. The button 32 is moveably mounted in the first pivot segment 14 of the housing 10, and has two hook segments 321 and an abutting pin 322. The hook segments 321 are respectively mounted through two of the switch holes 141 of the first pivot segment 14. The abutting pin 322 is mounted through the remaining one of the switch holes 141 of the first pivot segment 14, and rotatably abuts the push switch body 31. Thus, the button 32 is pushed out by the push switch body 31 until the hook segments 321 abut edges of the two switch holes 141. The push switch body 31 is rotated by the illuminating body 20 relative to the button 32 of the housing 10. Regardless of the relative rotation, the abutting pin 322 still abuts the push switch body 31, such that the user still can switch on and off the illuminating body 20.

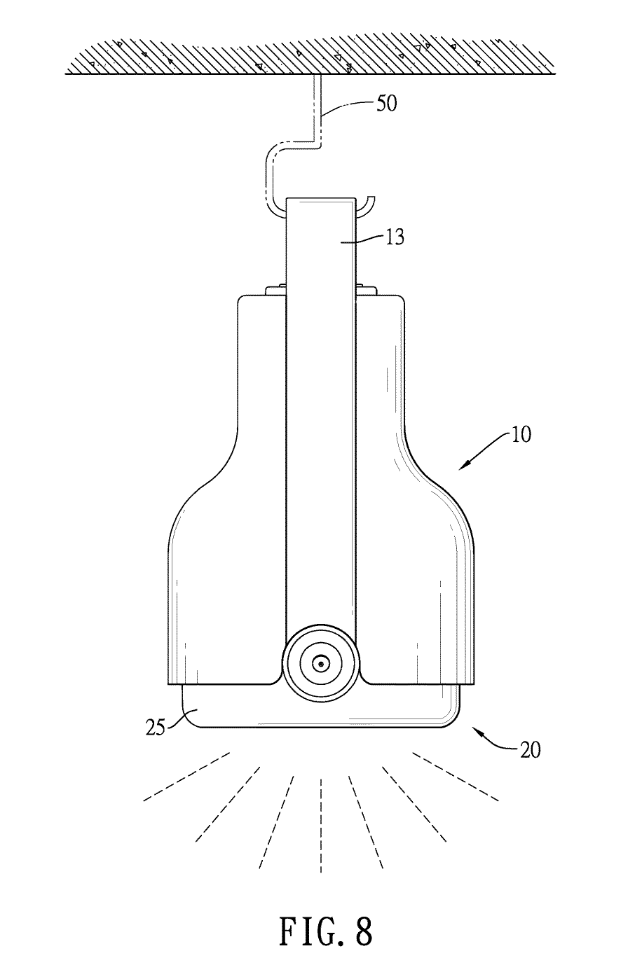

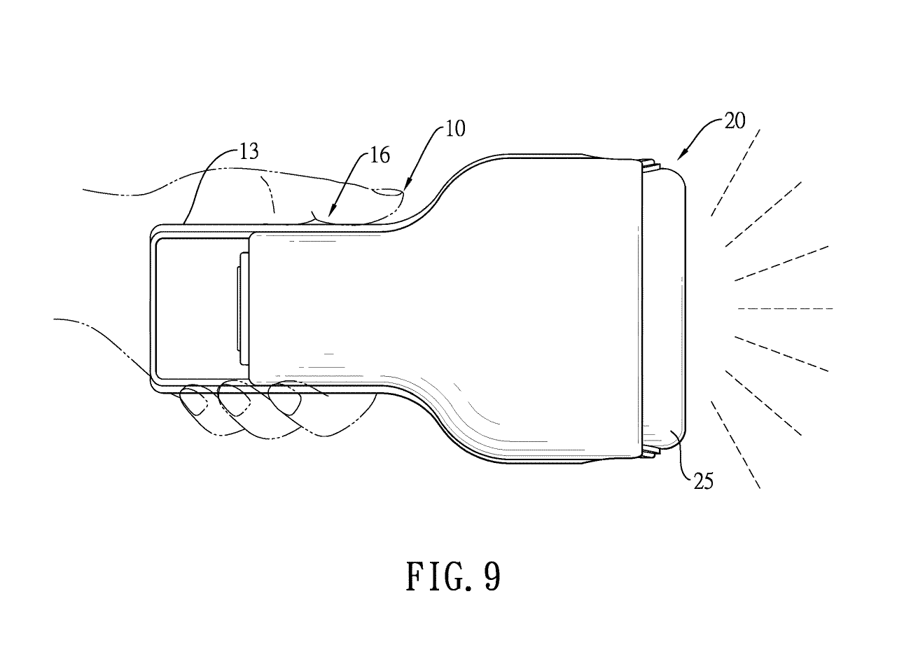

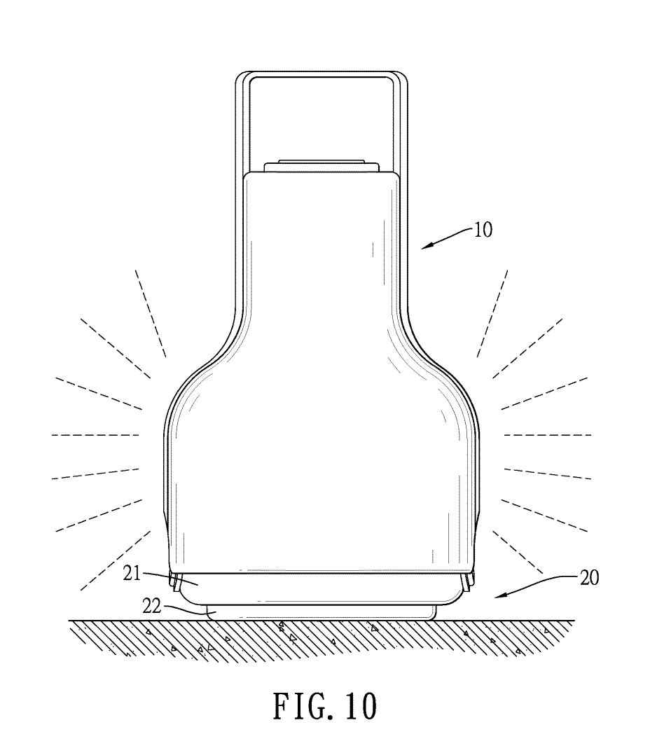

When the rotatable illuminator as described is in use as shown in FIG. 8, the illuminating body 20 is rotated until the illuminating elements are toward the opening of the housing 10. At this time, the rotatable illuminator can be hanged up by a hook 50 on the hanger 13 of the housing 10 to be used as a hanging lantern. With reference to FIG. 9, the user also can directly grab and hold the holding part 16 or the hanger 13 to use the rotatable illuminator as a flashlight. With reference to FIG. 10, when the illuminating body 20 is rotated until the illuminating elements are toward the inner space of the housing 10, the rotatable illuminator can be put on a table 60. At this time, the outer surface of the battery cover 22 of the illuminating body 20 abuts the table 60, and the light from the illuminating elements penetrates through and emits out of the translucent or transparent housing 10, such that the rotatable illuminator can be used as a table lamp. The rotatable illuminator can be used as the hanging lantern, the flashlight, and the table lamp as mentioned above, and thus can reduce the cost and facilitate ease in portability.

In another preferred embodiment, the housing may not be made of translucent or transparent material, and the housing has multiple through holes formed therethrough instead. The through holes on the housing also enable light to penetrate through and emit out and thus the rotatable illuminator still can be used as a table lamp.

In another preferred embodiment, the housing may be implemented without a hanger formed on the housing, and the housing has a through hole formed therethrough instead. The through hole enables a hook to hook on the housing, and thus the rotatable illuminator still can be used as a hanging lantern. In addition, the user still can directly grab and hold the housing to use the rotatable illuminator as a flashlight.

In another preferred embodiment, the switch may not be a push switch, and is altered into a touch switch.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A rotatable illuminator comprising:
a housing having
an inner space; and
an opening communicating with the inner space;
an illuminating body rotatably mounted in the housing, disposed adjacent to the opening of the housing, and having
at least one illuminating element;
wherein the illuminating body is rotatable relative to the housing to make the at least one illuminating element toward the opening of the housing or toward the inner space of the housing; and
a switch mounted on the housing, electrically connected to the illuminating body, and disposed in an end of a rotating axis between the housing and the illuminating body.

2. The rotatable illuminator as claimed in claim 1, wherein the housing has a hanger disposed in an end opposite to the opening of the housing.

3. The rotatable illuminator as claimed in claim 1, wherein the housing is made of translucent or transparent materials.

4. The rotatable illuminator as claimed in claim 1, wherein the illuminating body has
a plane surface disposed in an end opposite to an illuminating direction of the at least one illuminating element.

5. The rotatable illuminator as claimed in claim 1, wherein
the housing has
an illuminating part; and
a holding part smaller than the illuminating part in diameter; and
the illuminating body is rotatably mounted in the illuminating part.

6. The rotatable illuminator as claimed in claim 1, wherein
the housing has
two pivot segments respectively formed on an inner surface of the housing and disposed opposite to each other; and
the illuminating body has
two pivot recesses formed in an outer surface of the illuminating body, disposed opposite to each other, and respectively and rotatably disposed around the two pivot segments.

7. The rotatable illuminator as claimed in claim 6, wherein
each one of the pivot segments has
multiple positioning recesses transversely formed in the pivot segment and annularly disposed apart from each other; and
each one of the pivot recesses has
at least one positioning protrusion transversely formed on an inner surface of the pivot recess, and each one of the at least one positioning protrusion selectively engaging in one of the positioning recesses of the corresponding pivot segment.

8. The rotatable illuminator as claimed in claim 1, wherein the illuminating body has
a charging hole disposed in an end of the rotating axis between the housing and the illuminating body and disposed opposite to the switch.

9. The rotatable illuminator as claimed in claim 1, wherein the illuminating body has
a battery holder disposed in the illuminating body; and
a battery cover detachably covered on the battery holder.

10. The rotatable illuminator as claimed in claim 1, wherein the switch has
a push switch body mounted on the illuminating body; and
a button moveably mounted on the housing, rotatably abutting the push switch body, and pushed out by the push switch body.
